(19) United States
(12) Patent Application Publication
(10) Pub. No.: US 2025/0156647 A1
(43) Pub. Date: May 15, 2025

(54) DIALOG SYSTEM AND METHOD WITH IMPROVED HUMAN-MACHINE DIALOG CONCEPTS

(71) Applicant: Fraunhofer-Gesellschaft zur Förderung der angewandten Forschung e.V., München (DE)

(72) Inventors: Fabian KÜCH, Erlangen (DE); Luzian HAHN, Erlangen (DE); Shima ASAADI, Erlangen (DE); Sabrina STEHWEIN, Erlangen (DE); Christian KROOS, Erlangen (DE); Farzad NADERI, Erlangen (DE)

(21) Appl. No.: 19/022,026

(22) Filed: Jan. 15, 2025

Related U.S. Application Data
(63) Continuation of application No. PCT/EP2023/076150, filed on Sep. 21, 2023.

(30) Foreign Application Priority Data
Sep. 29, 2022 (WO) PCT/EP2022/077210

(51) Int. Cl. G06F 40/35; G06F 40/284; G10L 15/18

(52) U.S. Cl. CPC G06F 40/35; G06F 40/284; G10L 15/1815

(57) ABSTRACT

A dialog system has an input interface for obtaining an input representation of an input by receiving the input and deriving the input representation from the input or by receiving the input representation, being an audio signal, speech or text representation, having a plurality of input representation elements, a preprocessor for preprocessing the input representation to generate preprocessed information having a plurality of preprocessed information elements, and such that each preprocessed information element depends on at least two information representation elements, two or more information extraction processors, each suitable to generate derived information from the preprocessed information according to an information extraction rule, and different from an information extraction rule of any other information extraction processor, and an output interface for generating an output, being an audio, textual and/or visual output and/or a signal for steering a machine, depending on the derived information from one or more information extraction processors.

### CROSS-REFERENCE TO RELATED APPLICATIONS

This application is a continuation of copending International Application No. PCT/EP2023/076150, filed Sep. 21, 2023, which is incorporated herein by reference in its entirety, and additionally claims priority from International Application No. PCT/EP2022/077210, filed Sep. 29, 2022, which is also incorporated herein by reference in its entirety.

### TECHNICAL FIELD

The present invention relates to a dialog system and a method with improved human-machine dialog concepts, and, in particular, to efficient information extraction in dialog systems.

### BACKGROUND OF THE INVENTION

Human-machine interaction (HMI) technology, in particular, Human-computer interaction (HCl) focuses on the design and the use of computer technology for providing new interfaces and ways of interaction between humans and machines, such as computers.

In this field, interfaces such as speech interfaces for the interaction between people and machines may be employed, where people communicate with a machine, and where, vice versa, the machine communicates with the human. To implement a meaningful dialog system for human machine interaction, sophisticated natural language processing concepts may be employed.

Natural language processing (NLP) is a subfield of computer science and artificial intelligence that relates to the interactions between machines, in particular, computers, and humans, and more particularly relates to processing and analyzing large amounts of natural language data. Artificial intelligence may be employed to make a computer capable to understand the content, including the contextual nuances of the language within them. Analyzing the speech content comprises accurately extracting information from the speech representation and classifying the information.

Conversational dialog systems or short dialog systems such as voice assistant systems play an important role in the digitalization of industry processes, home automation, or entertainment applications. A user can interact with the dialog system using a voice interface. Another example are chatbots where the user may interact by typing text into a chatbot interface. In goal-oriented dialog systems (see [4]), the users are typically guided by the dialog system in order to complete a use case specific task such as booking transportation tickets, starting phone calls, collecting information or managing a calendar. A common way to define the possible interaction of a user with the dialog system is to specify states and transitions of dialog paths, e.g., using a graph-based representation in a tree-like structure or representing them as blocks of a flow diagram.

FIG. 2 illustrates a dialog graph depicting an example for a user interaction with a dialog system, wherein states and transitions of dialog paths are depicted. Depending on the state within the dialog, i.e., the interaction with the user, the dialog system has to perform different actions, e.g., give an appropriate response to the user. In some states, the dialog system has to identify the actual intent of the user based on user input. This user input may, for example, be speech or a speech representation of a user utterance in a voice assistant system. Or, for example, the user input may, for example, be text, for example, that has been typed into a chatbot or its textual transcription.

In a dialog system for banking application, for example, the system may have to identify whether the intent of a user is to check an account balance or whether the intent is to initiate a money transfer to another account. The task of mapping a user input to a set of predefined intent categories is commonly referred to as intent classification (see [2]).

In the following, it is distinguished between so-called local intents and so-called global intents. Local intents are denoted as intents that are only relevant at specific dialog states, i.e., for specific states of the interaction of a user with the dialog system. Corresponding intent classifiers are called local intent classifiers. On the other hand, global intents can be triggered by a user at any point during the interaction with the dialog system. Their relevancy does not depend on a specific state of the dialog. Examples for global intents are a “stop” command to stop the dialog system or “play music” intent to play music on a smart speaker at any point during the conversation with the dialog system. The dialog system may have to identify both types of intents simultaneously, where the specific local intents to be identified depend on the actual state of a dialog.

In some applications, a dialog system is configured to serve different tasks or domains which is commonly referred to as a multi-domain dialog system (see [5]). The dialog configuration for these different domains can, e.g., be represented by a parallel set of unconnected dialog graphs. FIG. 3 illustrates such a dialog configuration. In some cases, the subgraphs associated with different domains may be connected with each other, but different entry or start points to these subgraphs are associated with different domains. Such multi-domain dialog systems use so-called domain classifiers to decide to which of the available domains a user input refers to.

In some use cases the dialog system does not only aim at extracting information related to the intent of the user or the domain that is relevant for a specific user input, but additional classification tasks are performed. Examples are dialog act classification, i.e., the user input is classified according to the type of utterance: e.g., whether it represents a question, a confirmation, a rejection or whether the user provides information to the system. In some cases, the dialog system has to extract information included in the input that can be considered as variables or so-called entities. For example, if the user input is “How is the weather in Berlin?”, the dialog should identify that the corresponding dialog act is a question, that the intent of the user is to get information about the weather and furthermore extract the term Berlin as an entity related to the location information. The extraction of information about entities or variables is commonly referred to as entity recognition (see [6]).

More generally speaking, dialog systems have to address a variety of information extraction tasks on the received input related to natural language understanding for which some examples are provided above. These tasks can be summarized as being addressed by an information extraction processor.

In modern dialog systems, the classification of intents, domains or dialog acts may, for example, be performed based on deep neural networks.

In state-of-the-art dialog systems, each of the different intent classifiers, domain classifiers or other classifiers are typically realized by a separate, dedicated deep neural network (DNN) that has been trained with corresponding training data including examples sentences for each of the classes to be identified by the classifier. In some cases, parts of the neural network parameters are initialized with pre-trained parameters of a separately trained neural network (see [1]), i.e. applying so-called transfer learning approaches (see [7]). Then the entire neural network is subsequently trained to adapt it to the actual classification task using annotated training data. Since the size of DNNs commonly used for intent or domain classification is typically very large, e.g., they may, for example, comprise several millions of parameters, this approach implies large requirements on memory consumption and computational complexity if several classifiers are evaluated simultaneously on the same user input.

### SUMMARY

According to an embodiment, a dialog system may have: an input interface for obtaining an input representation of an input by receiving the input and deriving the input representation from the input or by receiving the input representation, the input representation being an audio signal representation or a speech representation or a text representation, wherein the input representation has a plurality of input representation elements, a preprocessor for preprocessing the input representation to generate preprocessed information, such that the preprocessed information has a plurality of preprocessed information elements, and such that each of two or more of the plurality of preprocessed information elements depends on at least two of the plurality of information representation elements, two or more information extraction processors, wherein each of the two or more information extraction processors is suitable to generate derived information from the preprocessed information according to an information extraction rule specific for the information extraction processor, and different from an information extraction rule of any other one of the two or more information extraction processors, and an output interface for generating an output, being an audio output and/or a textual output and/or visual output and/or being a signal for steering a machine, depending on the derived information from one or more of the two or more information extraction processors.

According to another embodiment, a dialog system may have: an input interface for obtaining an input representation of an input by receiving the input and deriving the input representation from the input or by receiving the input representation, the input representation being an audio signal representation or a speech representation or a text representation, wherein the input representation has a plurality of input representation elements, and two or more information extraction processors, wherein each of the two or more information extraction processors is suitable to generate derived information depending on the input representation according to an information extraction rule specific for the information extraction processor, and different from an information extraction rule of any other one of the two or more information extraction processors, and an output interface for generating an output, being an audio output and/or a textual output and/or visual output and/or being a signal for steering a machine, depending on the derived information from one or more of the two or more information extraction processors, wherein at least two information extraction processors of the two or more information extraction processors are dialog-state-dependent, wherein the dialog system is configured to select one or more information extraction processors of the at least two information extraction processors, which are dialog-state-dependent, depending on a current state of the dialog, such that only those of the at least two information extraction processors, which are associated with the current state of the dialog, are selected, and wherein the one or more information extraction processors that have been selected are configured to generate the derived information depending on their information extraction rules.

According to another embodiment, a method may have the steps of: obtaining an input representation of an input by an input interface of a dialog system, wherein the input interface obtains the input representation by receiving the input and deriving the input representation from the input or by receiving the input representation, wherein the input representation is an audio signal representation or a speech representation or a text representation, wherein the input representation has a plurality of input representation elements, preprocessing the input representation by a preprocessor of the dialog system to generate preprocessed information, such that the preprocessed information has a plurality of preprocessed information elements, and such that each of two or more of the plurality of preprocessed information elements depends on at least two of the plurality of information representation elements; wherein each of two or more information extraction processors of the dialog system is suitable to generate derived information from the preprocessed information according to an information extraction rule specific for the information extraction processor, and different from an information extraction rule of any other one of the two or more information extraction processors, and generating, by an output interface of the dialog system, an output, being an audio output and/or a textual and/or visual output and/or being a signal for steering a machine, depending on the derived information from one or more of the two or more information extraction processors.

According to another embodiment, a method may have the steps of: obtaining an input representation of an input by an input interface of a dialog system, wherein the input interface obtains the input representation by receiving the input and deriving the input representation from the input or by receiving the input representation, wherein the input representation is an audio signal representation or a speech representation or a text representation, wherein the input representation has a plurality of input representation elements; wherein each of two or more information extraction processors of the dialog system is suitable to generate derived information depending on the input representation according to an information extraction rule specific for the information extraction processor, and different from an information extraction rule of any other one of the two or more information extraction processors, and generating, by an output interface of the dialog system, an output, being an audio output and/or a textual and/or visual output and/or being a signal for steering a machine, depending on the derived information from one or more of the two or more information extraction processors, wherein at least two information extraction processors of the two or more information extraction processors are dialog-state-dependent, wherein the method has selecting by the dialog system one or more information extraction processors of the at least two information extraction processors, which are dialog-state-dependent, depending on a current state of the dialog, such that only those of the at least two information extraction processors, which are associated with the current state of the dialog, are selected, and wherein the method has generating the derived information by the one or more information extraction processors that have been selected depending on their information extraction rules.

Still another embodiment may have a non-transitory computer-readable medium having a computer program for implementing the above method s when being executed on a computer or signal processor.

A dialog system according to an embodiment is provided. The dialog system comprises an input interface for obtaining an input representation of an input by receiving the input and deriving the input representation from the input or by receiving the input representation, the input representation being an audio signal representation or a speech representation or a text representation, wherein the input representation comprises a plurality of input representation elements. Moreover, the dialog system comprises a preprocessor for preprocessing the input representation to generate preprocessed information, such that the preprocessed information comprises a plurality of preprocessed information elements, and such that each of two or more of the plurality of preprocessed information elements depends on at least two of the plurality of information representation elements. Moreover, the dialog system comprises two or more information extraction processors, wherein each of the two or more information extraction processors is suitable to generate derived information from the preprocessed information according to an information extraction rule specific for the information extraction processor, and different from an information extraction rule of any other one of the two or more information extraction processors. Furthermore, the dialog system comprises an output interface for generating an output, being an audio output and/or a textual output and/or visual output and/or being a signal for steering a machine, depending on the derived information from one or more of the two or more information extraction processors.

According to an embodiment, the dialog system may, e.g., be configured to select at least one of the two or more information extraction processors, such that only those of the two or more information extraction processors that have been selected, are to generate, depending on their information extraction rules, the derived information.

In an embodiment, at least two of the two or more information extraction processors may, e.g., generate the derived information from the preprocessed information depending on their information extraction rules.

Moreover, a dialog system according to another embodiment is provided. The dialog system comprises an input interface for obtaining an input representation of an input by receiving the input and deriving the input representation from the input or by receiving the input representation, the input representation being an audio signal representation or a speech representation or a text representation, wherein the input representation comprises a plurality of input representation elements. Furthermore, the dialog system comprises two or more information extraction processors, wherein each of the two or more information extraction processors is suitable to generate derived information depending on the input representation according to an information extraction rule specific for the information extraction processor, and different from an information extraction rule of any other one of the two or more information extraction processors. Moreover, the dialog system comprises an output interface for generating an output, being an audio output and/or a textual output and/or visual output and/or being a signal for steering a machine, depending on the derived information from one or more of the two or more information extraction processors. At least two information extraction processors of the two or more information extraction processors are dialog-state-dependent. The dialog system is configured to select one or more information extraction processors of the at least two information extraction processors, which are dialog-state-dependent, depending on a current state of the dialog, such that only those of the at least two information extraction processors, which are associated with the current state of the dialog, are selected. The one or more information extraction processors that have been selected are configured to generate the derived information depending on their information extraction rules.

Moreover, a method according to an embodiment is provided. The method comprises:
Obtaining an input representation of an input by an input interface of a dialog system, wherein the input interface obtains the input representation by receiving the input and deriving the input representation from the input or by receiving the input representation, wherein the input representation is an audio signal representation or a speech representation or a text representation, wherein the input representation comprises a plurality of input representation elements.
Preprocessing the input representation by a preprocessor of the dialog system to generate preprocessed information, such that the preprocessed information comprises a plurality of preprocessed information elements, and such that each of two or more of the plurality of preprocessed information elements depends on at least two of the plurality of information representation elements, wherein each of two or more information extraction processors of the dialog system is suitable to generate derived information from the preprocessed information according to an information extraction rule specific for the information extraction processor, and different from an information extraction rule of any other one of the two or more information extraction processors. And:
Generating, by an output interface of the dialog system, an output, being an audio output and/or a textual and/or visual output and/or being a signal for steering a machine, depending on the derived information from one or more of the two or more information extraction processors.

According to an embodiment, selecting by the dialog system at least one of the two or more information extraction processors may, e.g., be conducted, such that only those of the two or more information extraction processors that have been selected, and generating, depending on their information extraction rules, the derived information. And/or:
In an embodiment, generating the derived information from the preprocessed information by at least two of the two or more information extraction processors may, e.g., be conducted. depending on their information extraction rules.

Furthermore, another method according to an embodiment is provided, which comprises:
Obtaining an input representation of an input by an input interface of a dialog system, wherein the input interface obtains the input representation by receiving the input and deriving the input representation from the input or by receiving the input representation, wherein the input representation is an audio signal representation or a speech representation or a text representation, wherein the input representation comprises a plurality of input representation elements; wherein each of two or more information extraction processors of the dialog system is suitable to generate derived information depending on the input representation according to an information extraction rule specific for the information extraction processor, and different from an information extraction rule of any other one of the two or more information extraction processors. And:
Generating, by an output interface of the dialog system, an output, being an audio output and/or a textual and/or visual output and/or being a signal for steering a machine, depending on the derived information from one or more of the two or more information extraction processors.

At least two information extraction processors of the two or more information extraction processors are dialog-state-dependent. The method comprises selecting by the dialog system one or more information extraction processors of the at least two information extraction processors, which are dialog-state-dependent, depending on a current state of the dialog, such that only those of the at least two information extraction processors, which are associated with the current state of the dialog, are selected. Moreover, the method comprises generating the derived information by the one or more information extraction processors that have been selected depending on their information extraction rules.

Furthermore, a computer program for implementing one of the above-described methods when being executed on a computer or signal processor is provided.

In the following, further embodiments are provided.

According to an embodiment, input (for example, input text or a representation of input text) may, e.g., be received in a dialog system, the information extraction processors that may, e.g., be relevant for the current state of the dialog may, e.g., be selected, and the input may, e.g., be processed by the selected information extraction processors to extract information from the input.

In an embodiment, an input (for example, input text or a representation of input text) may, e.g., be received in a dialog system, the input may, e.g., be processed by a feature extractor to obtain an input feature vector from the input, and the obtained input feature vector may, e.g., be processed by at least two different information extraction processors to extract information from the input.

According to an embodiment, an input (for example, input text or a representation of input text) may, e.g., be received in a dialog system, the input may, e.g., be processed by a feature extractor to obtain an input feature vector from the input, the information extraction processors that may, e.g., be relevant for the current state of the dialog may, e.g., be selected, and the obtained input feature vector may, e.g., be processed by the selected information extraction processors to extract information from the input.

In an embodiment, an input for example, input text or a representation of input text) may, e.g., be received in a dialog system, the input may, e.g., be processed by a feature extractor to obtain an input feature vector from the input, the classifiers that may, e.g., be relevant for the current state of the dialog may, e.g., be selected, and the classification may, e.g., be performed based on a set of different class representation vectors representing the set of classes supported by the classifier block and using a distance metric between the class representation vectors and the input feature vector of the input to perform the classification.

According to an embodiment, an input (for example, input text or a representation of input text) may, e.g., be received in a dialog system, the input may, e.g., be processed by a feature extractor to obtain an input feature vector from the input, the classifiers that may, e.g., be relevant for the current state of the dialog may, e.g., be selected, the input feature vector may, e.g., be processed by the selected classification blocks to obtain classifier-specific feature vectors for each of the classifier blocks, and the classification in each classifier block may, e.g., be performed based on the corresponding classifier-specific feature vectors. Optionally, performing the classification may, for example, be based on a set of different class representation vectors representing the set of classes supported by the classifier block and using a distance metric between the class representation vectors and the classifier-specific feature vector of the input to perform the classification. An information extraction processor may, for example, be employed in such an embodiment.

In an embodiment, the input (for example, input text or a representation of input text) to be classified may, for example, be represented by a corresponding vector x, for example, a numerical vector x.

According to an embodiment, the input may, e.g., be input text or may, e.g., be a representation of input text.

In an embodiment, a speech recognition system may, e.g., generate the input text from user speech recorded by one or more microphones.

In an embodiment the input may, e.g., be speech, for example, a speech signal or may, e.g., be a representation of speech.

According to an embodiment, the input may, e.g., comprise a plurality of phonetic posteriorgrams, or may, e.g., comprise a representation of a plurality of phonetic posteriorgrams.

### BRIEF DESCRIPTION OF THE DRAWINGS

In the following, embodiments of the present invention are described in more detail with reference to the figures, in which:

FIG. 1a illustrates a dialog system according to an embodiment;

FIG. 1b illustrates a dialog system according to another embodiment;

FIG. 2 illustrates a dialog graph depicting an example for a user interaction with a dialog system, wherein states and transitions of dialog paths are depicted;

FIG. 3 illustrates a dialog configuration for different domains as a parallel set of unconnected dialog graphs;

FIG. 4 illustrates a general form of a deep neural network for classifying intents, domains or dialog acts based on an input vector;

FIG. 5 illustrates a neural network of a dialog system according to an embodiment, wherein a first part of the neural network is configured to determine a feature representation and the second part of the neural network is configured to conduct a classification depending on the feature representation;

FIG. 6 illustrates an embodiment, wherein different classifiers a applied simultaneously to provide classification results for different classification tasks;

FIG. 7 illustrates an embodiment, wherein different classifier-specific feature vector representations are employed for different classifiers;

FIG. 8 illustrates states and transitions of a dialog system according to an embodiment; and

FIG. 9 illustrates a neural network structure according to an embodiment.

### DETAILED DESCRIPTION OF THE INVENTION

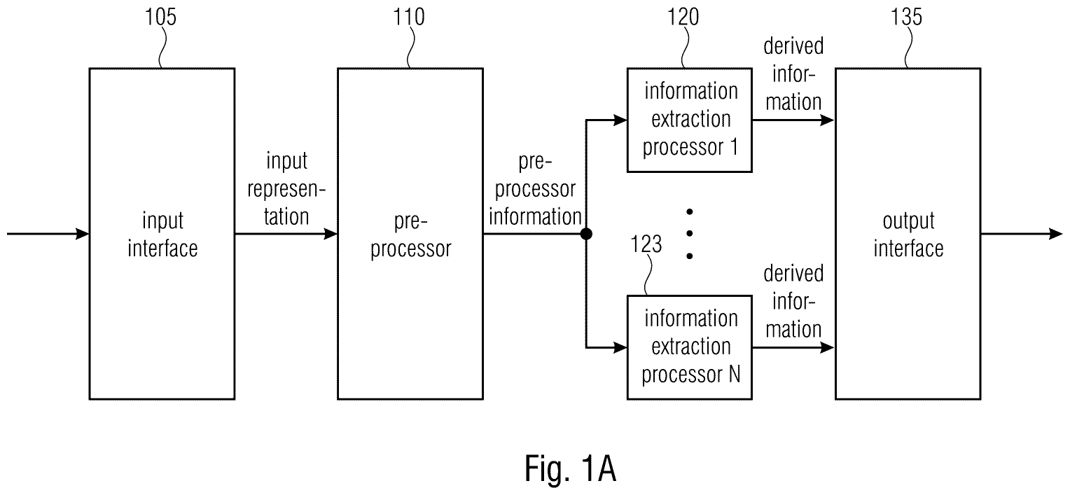

According to an embodiment, illustrated by FIG. 1a, a dialog system comprises an input interface 105 for obtaining an input representation of an input by receiving the input and deriving the input representation from the input or by receiving the input representation, the input representation being an audio signal representation or a speech representation or a text representation, wherein the input representation comprises a plurality of input representation elements.

Moreover, the dialog system comprises a preprocessor 110 for preprocessing the input representation to generate preprocessed information, such that the preprocessed information comprises a plurality of preprocessed information elements, and such that each of two or more of the plurality of preprocessed information elements depends on at least two of the plurality of information representation elements.

Furthermore, the dialog system comprises two or more information extraction processors 120, 123, wherein each of the two or more information extraction processors 120, 123 is suitable to generate derived information from the preprocessed information according to an information extraction rule specific for the information extraction processor, and different from an information extraction rule of any other one of the two or more information extraction processors 120, 123.

Moreover, the dialog system comprises an output interface 135 for generating an output, being an audio output and/or a textual output and/or visual output and/or being a signal for steering a machine, depending on the derived information from one or more of the two or more information extraction processors 120, 123.

According to an embodiment, the dialog system may, e.g., be configured to select at least one of the two or more information extraction processors 120, 123, such that only those of the two or more information extraction processors 120, 123 that have been selected, are to generate, depending on their information extraction rules, the derived information.

In an embodiment, at least two of the two or more information extraction processors 120, 123 may, e.g., generate the derived information from the preprocessed information depending on their information extraction rules. For example, said at least two of the two or more information extraction processors 120, 123 may, e.g., be configured to generate the derived information from the preprocessed information in parallel.

According to an embodiment, the dialog system may, e.g., be configured to select the at least one of the two or more information extraction processors 120, 123 depending on a current state of a dialog, such that those of the two or more information extraction processors 120, 123 that have been selected, are to generate, depending on their information extraction rules, the derived information.

In an embodiment, at least two information extraction processors 120, 123 of the two or more information extraction processors 120, 123 may, e.g., be dialog-state-dependent. The dialog system may, e.g., be configured to select one or more information extraction processors 120, 123 of the at least two information extraction processors 120, 123, which are dialog-state-dependent, depending on the current state of the dialog, such that only those of the at least two information extraction processors 120, 123, which are associated with the current state of the dialog, are selected. Each of the one or more information extraction processors 120, 123 that have been selected may, e.g., be configured to generate the derived information depending on its information extraction rule.

According to an embodiment, the dialog system comprises three or more information extraction processors 120, 123 as the two or more information extraction processors 120, 123. At least one information extraction processor 120, 123 of the three or more information extraction processors 120, 123 may, e.g., be dialog-state-independent. The at least one information extraction processor 120, 123, which is dialog-state-independent, may, e.g., be configured to always generate, depending on its information extraction rule, the derived information, independent from the current state.

According to an embodiment, each of at least two information extraction processors 120, 123 of the two or more information extraction processors 120, 123 may, e.g., be suitable to generate specific information being specific for said information extraction processor according to a modification rule, wherein said information extraction processor is suitable to generate the derived information from the specific information for said information extraction processor according to the information extraction rule specific for the information extraction processor. Said information extraction processor may, e.g., be suitable to generate the specific information for said information extraction processor according to the modification rule, such that the specific information for said information extraction processor is different from any specific information of any other information extraction processor of the at least two information extraction processors 120, 123.

According to an embodiment, each of at least one of the at least two information extraction processors 120, 123 may, e.g., be configured to generate the specific information for said information extraction processor using the derived information of another one of the at least two information extraction processors 120, 123.

In an embodiment, the dialog system may, e.g., be configured to select at least one information extraction processor of the at least two information extraction processors 120, 123 depending on the current state of the dialog, such that each of said at least one information extraction processor may, e.g., generate the derived information from the specific information for said one of the at least one information extraction processor.

According to an embodiment, each of the two or more information extraction processors 120, 123 may, e.g., be a classification unit. Each of the two or more classification units may, e.g., be suitable to generate the derived information from the preprocessed information such that the derived information indicates whether or not the input representation may, e.g., be associated with a class or indicates a probability that the input representation may, e.g., be associated with the class.

In an embodiment, the preprocessed information may, e.g., comprise a numerical feature vector. The plurality of preprocessed information elements may, e.g., comprise a plurality of numerical vector components of the feature vector.

According to an embodiment, the input interface 105 may, e.g., be configured to obtain a raw input text as the input representation, being a sequence of words. The preprocessor 110 may, e.g., be configured to tokenize the raw input text using a tokenization method to obtain a plurality of tokens. Moreover, the preprocessor 110 may, e.g., be configured to generate a multi-dimensional numerical vector for each of the plurality of tokens to obtain a plurality of multi-dimensional numerical vectors. Furthermore, the preprocessor 110 may, e.g., be configured to generate the numerical feature vector of the preprocessed information by combining the plurality of multi-dimensional numerical vectors for the plurality of tokens.

According to an embodiment, for each information extraction processor of the at least one information extraction processors 120, 123 that has been selected, said information extraction processor may, e.g., be configured to generate the specific information such that it comprises a numerical feature vector depending on the numerical feature vector of the preprocessed information. Moreover, said information extraction processor may, e.g., be configured to generate the derived information for said information extraction processor by determining a distance metric between the specific information of said information extraction processor and a numerical class representation vector being associated with said information extraction processor.

In an embodiment, each information extraction processor of the two or more information extraction processors 120, 123 may, e.g., comprise a neural network, wherein the neural network may, e.g., comprise at least one of an attention layer, a pooling layer and a fully-connected layer. The neural network may, e.g., be configured to receive the preprocessed information as input, and may, e.g., be configured to output the derived information; or the neural network may, e.g., be configured to receive the specific information for said information extraction processor as input, and may, e.g., be configured to output the derived information.

According to an embodiment, the pre-processor may, e.g., be configured to generate the preprocessed information such that each of the plurality of information elements depends on each of the plurality of information representation elements.

In an embodiment, the pre-processor may, e.g., comprise a neural network which may, e.g., be configured to receive the plurality of input representation elements as input, and which may, e.g., be configured to output the plurality of preprocessed information elements as output. The neural network may, e.g., comprise at least two of an attention layer, a pooling layer and a fully-connected layer.

According to an embodiment, the input representation may, e.g., comprise a numerical multi-dimensional sentence representation vector, or wherein the preprocessor 110 may, e.g., be configured to generate the numerical multi-dimensional sentence representation vector from the input representation, wherein the numerical multi-dimensional sentence representation vector identifies a sentence or portions of a sentence, e.g., according to a user utterance, wherein the multi-dimensional sentence representation vector may, e.g., comprise three or more numerical vector elements, wherein each of the three or more numerical vector elements may, e.g., be associated with one of a plurality of dimensions.

In an embodiment, for each two pairs of the plurality of numerical multi-dimensional sentence representation vectors for a plurality of sentences of the input representation, two numerical multi-dimensional sentence representation vectors of a first one of the two pairs of the numerical multi-dimensional sentence representation vectors that identify two first sentences with semantically related meaning have a smaller spatial distance in a multi-dimensional space, in which the plurality of numerical multi-dimensional sentence representation vectors is defined, than two numerical multi-dimensional sentence representation vectors of a second one of the two pairs of the numerical multi-dimensional sentence representation vectors that identify two second sentences with semantically non-related meaning. Or, the preprocessor 110 may, e.g., be configured to generate the plurality of numerical multi-dimensional sentence representation vectors, such that for each two pairs of the plurality of numerical multi-dimensional sentence representation vectors, two numerical multi-dimensional sentence representation vectors of a first one of the two pairs of the numerical multi-dimensional sentence representation vectors that identify two first sentences with semantically related meaning have a smaller spatial distance in a multi-dimensional space, in which the plurality of numerical multi-dimensional sentence representation vectors is defined, than two numerical multi-dimensional sentence representation vectors of a second one of the two pairs of the numerical multi-dimensional sentence representation vectors that identify two second sentences with semantically non-related meaning. A spatial distance may, for example, be an Euclidian distance or a sine similarity or cosine similarity.

FIG. 1b illustrates a dialog system according to another embodiment.

The dialog system of FIG. 1ab comprises an input interface 105 for obtaining an input representation of an input by receiving the input and deriving the input representation from the input or by receiving the input representation, the input representation being an audio signal representation or a speech representation or a text representation, wherein the input representation comprises a plurality of input representation elements.

Furthermore, the dialog system comprises two or more information extraction processors 120, 123, wherein each of the two or more information extraction processors 120, 123 is suitable to generate derived information depending on the input representation according to an information extraction rule specific for the information extraction processor, and different from an information extraction rule of any other one of the two or more information extraction processors 120, 123.

Moreover, the dialog system comprises an output interface 135 for generating an output, being an audio output and/or a textual output and/or visual output and/or being a signal for steering a machine, depending on the derived information from one or more of the two or more information extraction processors 120, 123.

At least two information extraction processors 120, 123 of the two or more information extraction processors 120, 123 are dialog-state-dependent. The dialog system is configured to select one or more information extraction processors 120, 123 of the at least two information extraction processors 120, 123, which are dialog-state-dependent, depending on a current state of the dialog, such that only those of the at least two information extraction processors 120, 123, which are associated with the current state of the dialog, are selected. The one or more information extraction processors 120, 123 that have been selected are configured to generate the derived information depending on their information extraction rules.

According to an embodiment, the dialog system comprises three or more information extraction processors 120, 123 as the two or more information extraction processors 120, 123. At least one information extraction processor 120, 123 of the three or more information extraction processors 120, 123 may, e.g., be dialog-state-independent. The at least one information extraction processor 120, 123, which is dialog-state-independent, may, e.g., be configured to always generate, depending on its information extraction rule, the derived information, independent from the current state.

In an embodiment, each of at least two information extraction processors 120, 123 of the two or more information extraction processors 120, 123 may, e.g., be suitable to generate specific information being specific for said information extraction processor according to a modification rule, wherein said information extraction processor is suitable to generate the derived information from the specific information for said information extraction processor according to the information extraction rule specific for the information extraction processor. Said information extraction processor may, e.g., be suitable to generate the specific information for said information extraction processor according to the modification rule, such that the specific information for said information extraction processor is different from any specific information of any other information extraction processor of the at least two information extraction processors 120, 123.

According to an embodiment, the input interface 105 may, e.g., be configured to receive the input being a speech signal or an audio signal. The input interface 105 may, e.g., be configured to apply a speech recognition algorithm on the speech signal or on the audio signal to obtain a text representation of the speech signal or of the audio signal as the input representation.

In a particular embodiment, a speech signal may, e.g., comprise a command to steer a machine. In response, the machine may, e.g., execute the command.

In the following, particular embodiments are described.

The input (for example, input text or a representation of input text) to be classified may, for example, be represented by a corresponding vector x, for example, a numerical vector x.

In the following, an advantageous embodiment to determine the preprocessed information based on text input is described. It follows the concept as described in [1].

First, the dialogue system receives a raw input text, which is a sequence of words. The input text is first tokenized, e.g., using the WordPiece tokenization method, e.g., as described by Wu et al in [11]. A token may, e.g., represent words, subwords, or only a portion of a word. Each token is then mapped/converted into a high-dimensional numerical vector representation through a matrix of size (N,D), called token embeddings matrix, where N is the size of the vocabulary and D is the size of the vectors in a high-dimensional vector space (multi-dimensional vector space). Each row of the matrix corresponds to a token in the vocabulary. Therefore, if, for example, the length of the input text is S=6 (it contains 6 tokens), and D is 768, corresponding token representations are extracted and the input text is represented by a matrix of size (6,768) in the vector space.

If the dialogue system receives a pair of raw input texts instead of a single input text, to distinguish the inputs, a “segment embeddings” matrix of shape (2,D) may, e.g., be used. In this matrix, The first row (with all values 0) is assigned to all tokens that belong to input 1 while the last row (with all values 1) is assigned to all tokens that belong to input 2. If an input text comprises only one input sequence, then its segment embedding will just be the first row of the segment embeddings matrix. Therefore, if a pair of inputs have a total length of 10 (4 for the first input, and 6 for the second input), then the segment representation of the pair may, e.g., be a matrix of size (10,768) with rows up to 4 are 0 and the other rows are 1. If the input text is a single input with length 6, the segment embeddings may, e.g., be a matrix of size (6,768) with all values as 0. This way, the language model in the dialogue system identifies which token belongs to which input. It should be noted that in our case, e.g., we always have a single input text.

Then, the position of tokens in the input text is represented with high-dimensional vector representations. To get the position vector of each token, a lookup table of size (L,D), called position embeddings, may, e.g., be used, where the first row is the vector representation of any token in the first position, the second row is the vector representation of any token in the second position, etc. Here, L shows the maximum sequence length, e.g., 512, that can be preprocessed by the language model of the dialogue system.

The token representations, segment representations, and position representations of the input text may, e.g., be summed element-wise to produce a single representation with shape (S,D), where s is the input text length (number of tokens) and d is the vector size in the high-dimensional vector space. This is the input representation that may, e.g., be passed to the first layer of the language model of the system.

A language model may, e.g., have several layers, e.g., 12, with identical architectures. Each layer may, e.g., comprise an attention network and a fully connected neural network. Both input and output of the layers may, e.g., be of shape (S,D). The previously computed input representation passes all layers and the output of the last layer may, e.g., be an output representation of the same shape (S,D).

To compute the preprocessed information to input to the information extraction processors, the output representation of size (S,D) from the language model may, e.g., be aggregated by taking the average of all the S token vectors element-wise, which may, e.g., result in a single high-dimensional vector representation of length D that may, e.g., correspond to the input text. This vector can be considered as a sentence representation vector or a sentence embedding or sentence embedding vector and it corresponds to the processed information as output by the preprocessor 110.

According to an embodiment, a speech signal may, e.g., be obtained from a microphone and a speech recognition algorithm may, e.g., be employed to derive text from the recorded microphone. The obtained text may, e.g., then be mapped by an algorithm to an input vector depending on a vocabulary.

Or, in another embodiment, the speech recognition algorithm may, e.g., be designed to map sentences comprised in the speech signal directly to the indices of the vocabulary.

According to another embodiment, a speech analysis algorithm may, e.g., be employed that maps a speech signal to indices of a vocabulary of a plurality of phonetic posteriorgrams to obtain a vector of indices of a vocabulary of phonetic posteriorgrams. In such a vocabulary of phonetic posteriorgrams, each of the phonetic posteriorgrams may, e.g., be represented by an index. A mapping algorithm may, e.g., then map the vector of indices of phonetic posteriorgrams to an index of words of a vocabulary of words.

In another embodiment, a vector of indices of phonetic posteriorgrams may, e.g., be directly processed as input of the feature extractor.

The neural network representing the classifier can in general be represented by a function f(A,x) with parameters A and input x.

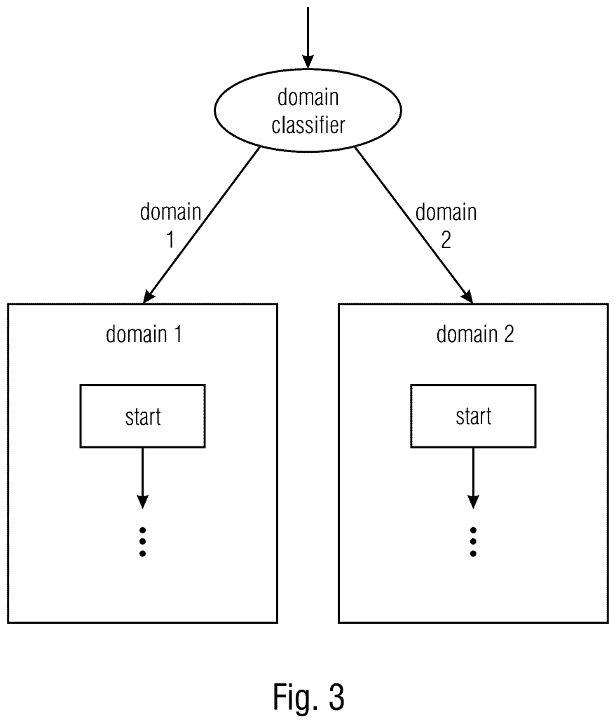

The output of the classifier may, e.g., be a vector c, where the elements cᵢ of c may, for example, be numerical scores that may, for example, be interpreted as the probability that the input x belongs to the class represented by cᵢ. This general approach to classification is illustrated in FIG. 4.

Particular embodiments solve the complexity issues mentioned above.

Some embodiments are based on the observation that a neural network used for classification can be interpreted as being composed of two parts:

The first part of the neural network computes so-called feature representations or embeddings from the user input.

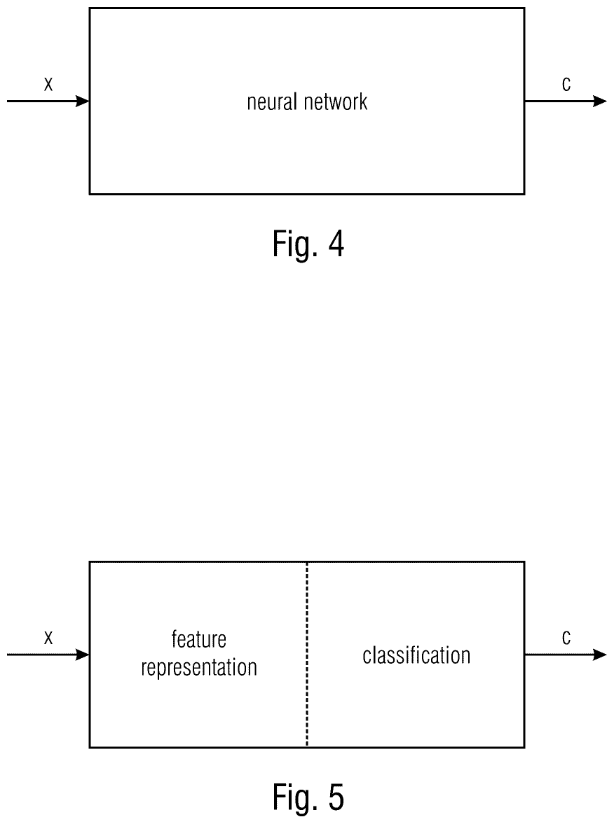

The second part of the neural network performs the actual classification task by processing the embeddings that have been determined by the first part of the neural network. This way of interpreting a neural network-based classification system of, e.g., intents, dialog acts, or domains is illustrated in FIG. 5.

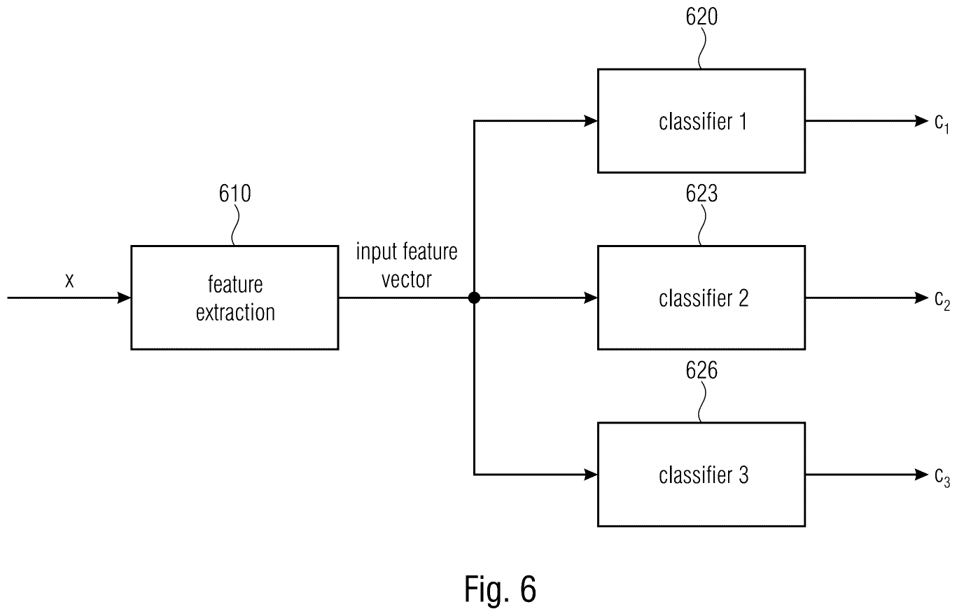

In an embodiment, the user input (for example, input text or a representation of input text) may, e.g., be processed by different classifiers, for example, simultaneously (for example, in parallel) in order to provide classification results for different classification tasks, e.g. local intent classification, global intent classification or domain classification. The proposed approach for this scenario is illustrated in FIG. 6 and includes multiple processing steps.

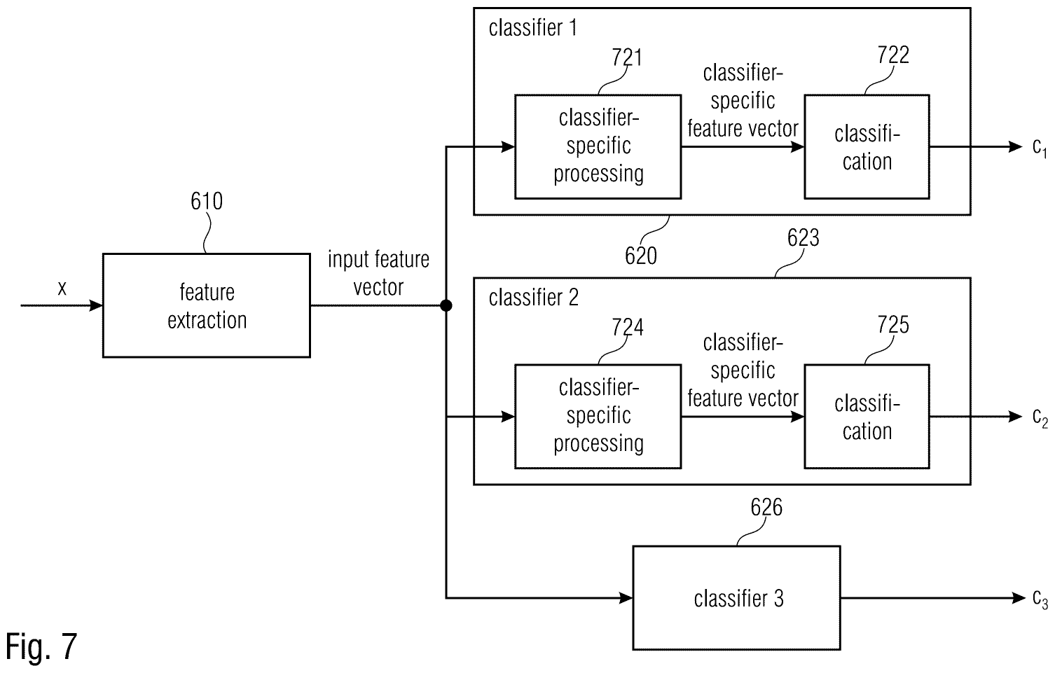

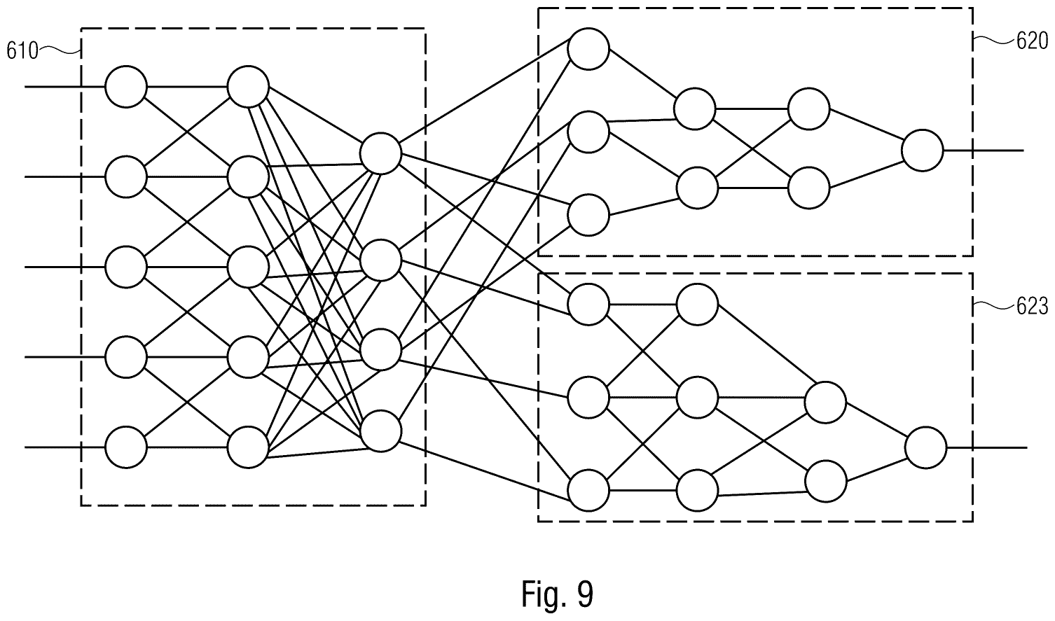

In FIG. 6, FIG. 7 and FIG. 9, the preprocessor 110 may, e.g., be implemented a feature extractor 610. Moreover, in FIG. 6, FIG. 7 and FIG. 9, the information extraction processors 120, 123 may, e.g., be implemented as classification units 620, 623, 626.

At first, the input (for example, input text or a representation of input text), e.g., the input vector, may, e.g., be processed by a feature extractor 610 to determine a corresponding feature vector or text embedding.

The feature extractor 610 may, for example, be realized by a neural network that has been trained to generate suitable feature vectors based on the input of the user, for example, by applying the concepts described in [9].

According to an embodiment, the concepts described in [10], in particular, the concepts in [10], chapter 3.2 may, e.g., be employed to derive a feature vector from text input or from the representation of the text input.

For example, in an embodiment, the input, for example, input text, may, e.g., first be transformed from text into sentence representation vectors or so-called sentence embeddings. These vectors may, e.g., be numeral vectors of dimension L, where the dimension of the sentence representation vectors may, for example, comprise between 100 and 1000 dimensions.

In an embodiment, the text or text representation may, e.g., be transformed to the sentence representation vectors, such that sentences that have a similar semantic meaning may, e.g., be spatially close to each other; e.g., may, e.g., have similar vector representations, e.g., measured by a distance metric, for example, an Euclidian distance or a sine similarity or cosine similarity.

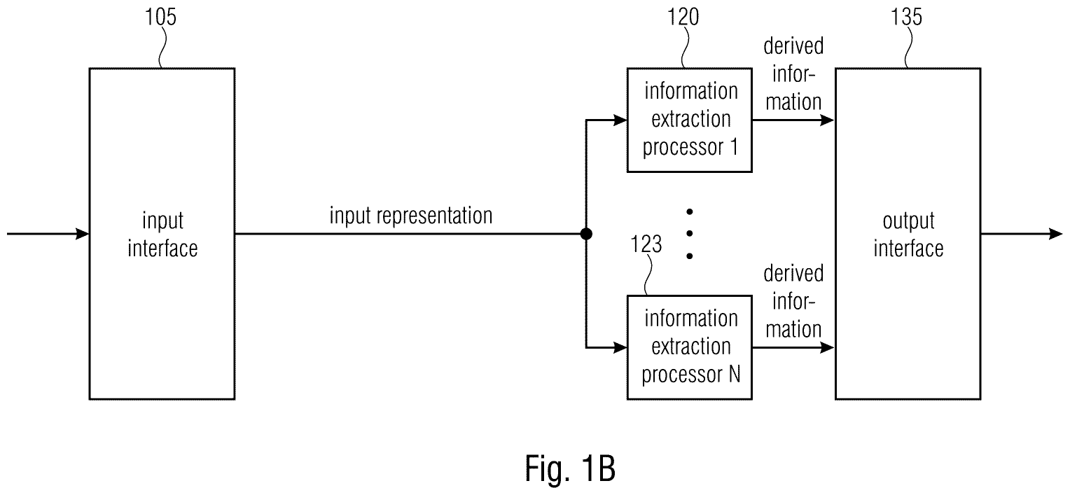

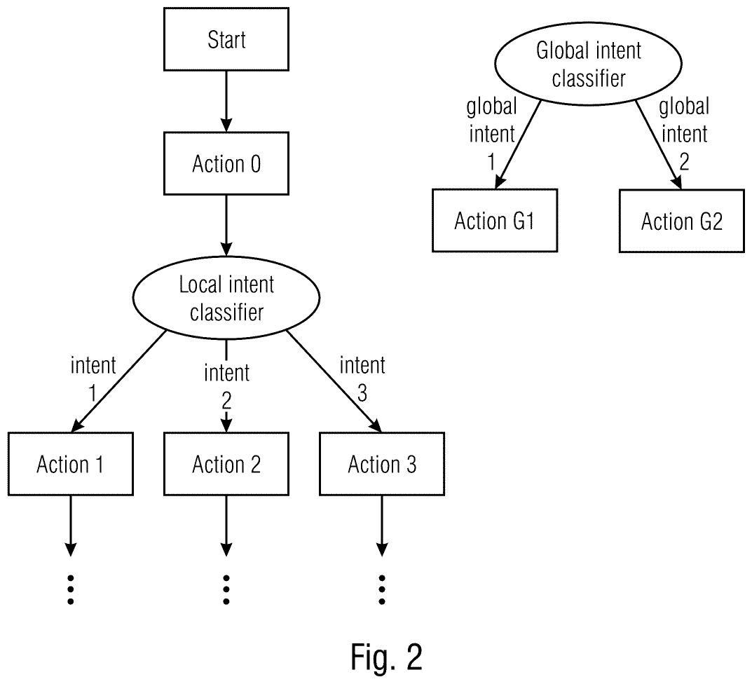

In an embodiment, a neural network may, e.g., be employed to generate a feature vector from the input. For example, the neural network may, e.g., comprise an attention layer and/or a pooling layer and/or a fully connected layer. In a particular layer, a configuration of a neural network may, e.g., be employed, that comprises an attention layer that is followed by a pooling layer. In a specific embodiment, the neural network may, moreover, for example, comprise a fully connected layer that follows the attention layer (see FIG. 2 of [10]).

The feature vector computed by the feature extractor 610 may, e.g., then be input into multiple classification units 620, 623, 626. Each of the classification units 620, 623, 626 may, e.g., be dedicated to solving a separate classification task and provide information related to the corresponding classification results. Each of the different classification units 620, 623, 626 may have been trained or configured differently, typically based on different training data.

The classification units 620, 623, 626 may, for example, be realized using neural networks that provide the classification information in form of an estimate of the probability that the input (for example, input text or a representation of input text) can be associated with a specific class. Alternatively, other classification approaches, for example, support vector machines or, for example, decision trees may, e.g., be employed.

FIG. 7 illustrates another embodiment, where the classification units 620, 623 first determine (for example, by first subunits 721, 724) a classifier-specific feature vector representation of the input from the input feature vector in order to obtain a classifier-specific feature vector representation of the input. Typically, the classifier-specific feature vector representations of the input are different for different classifiers.

The classification may, e.g., then be performed (for example, by second subunits 722, 725) based on distance measures between the classifier-specific feature vector and a set of different class representation vectors representing the set of classes supported by the respective classification units 620, 623.

Different classification units 620, 623 may therefore use a different set of class representation vectors where each of the class representation vectors is associated with a specific class or label. Commonly, the closer the classifier-specific feature vector is to the representation vector of a class the larger the probability may be that the input belongs to that class. The classification units 620, 623 (e.g., the second subunits 722, 725) may, e.g., select the class, for which the distance measure between the classifier-specific feature vector of the input and the representation vector of the class is minimum. For example, an Euclidean distance measure may, e.g., be employed. In other embodiments, another distance measure, for example, a cosine distance, or, for example, a sine distance, may, e.g., alternatively be employed.

In some embodiments, the computation of the classifier-specific feature vector representation (e.g., by the first subunits 721, 724) may, e.g., be performed based on a linear projection of the input feature vector. The linear projection may, for example, be represented by a corresponding projection matrix, where typically the projection matrices are chosen differently for different classifiers, e.g., based on the training data associated with the specific classifier (see [8]).

In some embodiments, the step of determining a classifier-specific feature vector is omitted. In this case, the class representation vectors associated with a specific classifier are directly compared to the input feature vector of the input text instead of comparing it to corresponding classifier specific feature vectors.

Usually, the computational complexity of computing the input feature vector from the input is much higher compared to the complexity of computing the classifier-specific feature vector based on the input feature vector. Therefore, the overall computational complexity is much lower for the proposed approach. Analogously, the number of parameters of the neural network for computing the input feature vectors is much higher than the number of parameters required to compute the classifier-specific feature vectors from the input feature vectors. This implies that the memory requirements using the proposed approach are smaller compared to a set of corresponding separate classifiers.

An additional way, according to some embodiments, to increase the efficiency and robustness of classification tasks in a dialog system is to not evaluate all classifiers (e.g. for all available intents, domains or dialog acts) of a dialog system, but only those classifiers that are required in a specific state of a dialog to decide on the appropriate next action of the dialog system. For example, following a graph-based representation of dialogs, the so-called global intents are relevant in every turn of the conversation of the user and the dialog system, i.e., they are required independently of the actual state of the dialog or the position within the graph-based representation of the dialog. An example of a global intent is given by a “stop” command that should stop the dialog system. On the other hand, so-called local intents are only relevant in a specific state of the dialog or a specific position within in the graph-based dialog representation in order to determine the next action of the dialog system.

In an embodiment, classifiers relating to local intents are only evaluated when required, e.g., depending on the specific state of the dialog. According to some embodiments, classifiers relating to global intents are always evaluated.

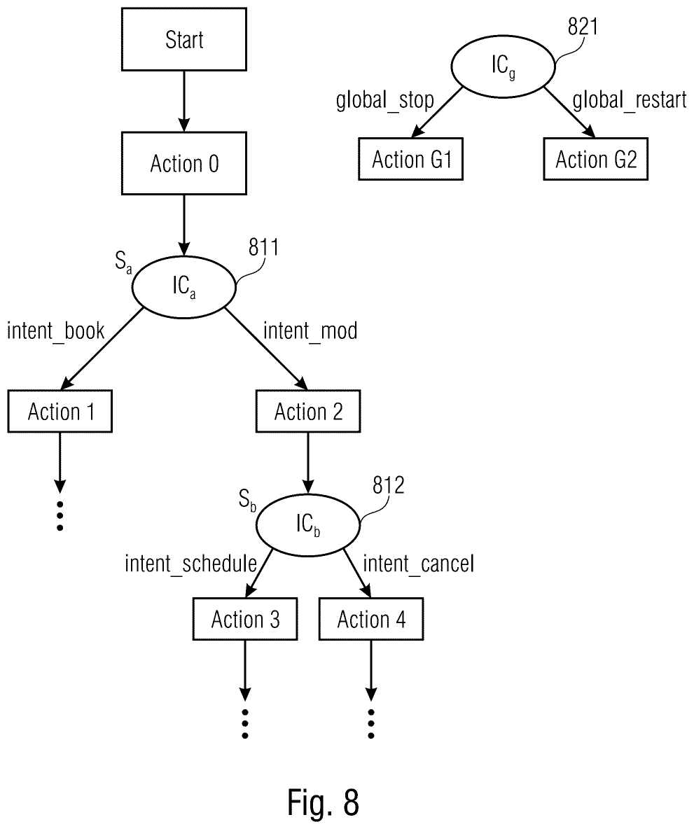

FIG. 8 illustrates an example, where a dialog system is considered that supports the user in performing different tasks such as booking transportation tickets or managing a calendar.

Let the dialog be designed such that in state Sa the dialog system requires the information whether the user's intent is to book a transportation ticket, I_{book} or whether the intent is to modify a present booking I_{mod}. This classification task is addressed by a corresponding local intent classifier ICₐ 811. In another state Sb, the dialog system requires information whether the user's intent is to schedule a new meeting or to cancel a calendar entry, which is handled by a corresponding local intent classifier IC_{b} 812. In addition to the local intent classifiers, it is assumed that there is a global intent classifier IC_{g} 821 in the dialog system which is used to detect whether general user intents such as stopping the dialog system or restarting the conversation with the dialog system.

For the case that the dialog system is in state Sa, the proposed approach is applied as follows. First, the user input (for example, input text or a representation of input text) is processed by the input feature extractor 610 which outputs an input feature vector.

Then, the classifiers 811, 821 that are relevant for the state Sa are selected from the set of available classifiers 811, 812, 821 of the dialog system. In the example here, the local intent classifier ICₐ 811 and the global intent classifier IC_{g} 821 are selected while IC_{b} 812 is not considered since it is not relevant in state Sa. The input feature vector is then processed by the classification units corresponding to ICₐ 811 and IC_{g} 821, respectively, whereas the classification unit of IC_{b} 812 is omitted. Analogously, if the dialog is in state Sb, the classification unit of IC_{g} 821 and IC_{b} 812 are selected for further processing of the input feature vector whereas the classification unit of ICₐ 811 is omitted.

FIG. 9 illustrates a neural network structure according to an embodiment. The preprocessor 610 (e.g., a feature extractor) may, e.g., be implemented as a first neural network. Two information extraction processors 620, 623 (e.g., two classification units) may, e.g., be implemented as two further neural networks. The output of the last layer of preprocessor 610 may, e.g., be the preprocessed information (e.g., a feature vector). Each preprocessed information element of the preprocessed information may, e.g., be fed into the first information extraction processor 620 as well as into the second information processor 623 which each generate their derived information (e.g., a classification result, for example, a probability that the input representation being fed into preprocessor 610 belongs to the particular class being associated with the respective classifier 620 or 623).

Alternatively, the neural network structure may, e.g., be implemented by a single neural network. The output of the last layer of preprocessor 610 may, e.g., the preprocessed information (e.g., the feature vector). In such a single neural network structure, no links may, e.g., exist between the nodes of information extraction processor 620 and the node of information extraction processor 623. Such a single neural network structure may, e.g., be trained with a large number of training data sets, wherein, for example, each of the training data sets having an input representation as input and a classification result (for example, either 1=input belongs to the class, or 0=input does not belong to the class) for each of the classification units 620 and 623).

Or, the neural network of the feature extractor 610 may, e.g., be implemented using a state-of-the-art neural network for obtaining a feature vector, such as BERT (see [1]) or SBERT (see [9]). The training data for the neural network of each of the of the classification units 620, 623 may, e.g., comprise the output of the state-of-the-art neural network 610 as input and a classification result for the classification associated with the respective classification unit 620 or 623 as output.

The above description of embodiments is in particular provided in relation to classification tasks and to intent classification. As mentioned above, there may, e.g., be additional information extraction tasks to be addressed by an information extraction processor of a dialog system. Examples include domain classification, dialog act classification or entity recognition. In embodiments, the proposed approach as described in the context of intent classification may, e.g., be applied analogously to these information extraction tasks, too. In this case not only intent classifiers may, e.g., be selected that are relevant for a specific dialog state, but additionally (or alternatively) information extraction processors 120, 123 related to domain classification, dialog act classification or entity recognition are selected from all available information extraction processors 120, 123 of the dialog system, which are relevant for the considered dialog state. The common input feature vector obtained from the input (for example, from input text or from a representation of input text) is then processed by the different information extraction processors 120, 123 that are relevant for the current dialog state in order to extract the required information.

Although some aspects have been described in the context of an apparatus or a dialog system, it is clear that these aspects also represent a description of the corresponding method, where a block or device corresponds to a method step or a feature of a method step. Analogously, aspects described in the context of a method step also represent a description of a corresponding block or item or feature of a corresponding apparatus or dialog system. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] Devlin, Jacob, Ming-Wei Chang, Kenton Lee, and Kristina Toutanova. 2019. “BERT: Pre-training of Deep Bidirectional Transformers for Language Understanding.”, In Proceedings of the 2019 Conference of the North American Chapter of the Association for Computational Linguistics: Human Language Technologies. Minneapolis: Association for Computational Linguistics. 4171-4186.
[2] Grosz, Barbara J., and Candace L. Sidner. 1986. “Attention, Intentions, and the Structure of Discourse.” Computational Linguistics 12:175-204.
[3] Louvan, Samuel, and Bernardo Magnini. 2020. “Recent Neural Methods on Slot Filling and Intent Classification for Task-Oriented Dialogue Systems: A Survey.” Proceedings of the 28th International Conference on Computational Linguistics. Barcelona, Spain (Online): International Committee on Computational Linguistics. 480-496.
[4] Young, Steve, Milica Gašić, Blaise Thomson, and Jason D. Williams. 2013. “POMDP-Based Statistical Spoken Dialog Systems: A Review” Proceedings of the IEEE 101 (5): 1160-1179.
[5] Qin, Libo, Xiao Xu, Wanxiang Che, Yue Zhang, and Ting Liu. 2020. “Dynamic Fusion Network for Multi-Domain End-to-end Task-Oriented Dialog.” Proceedings of the 58th Annual Meeting of the Association for Computational Linguistics. Online: Association for Computational Linguistics. 6344-6354.
[6] Yadav, Vikas, and Steven Bethard. 2018. “A Survey on Recent Advances in Named Entity Recognition from Deep Learning models.” Proceedings of the 27th International Conference on Computational Linguistics. Santa Fe, New Mexico, USA: Association for Computational Linguistics. 2145-2158.
[7] Pan, Sinno Jialin, and Qiang Yang. 2010. “A Survey on Transfer Learning.” IEEE Transactions on Knowledge and Data Engineering 1345-1359.
[8] Weinberger, Kilian Q, and Lawrence K. Saul. 2009. “Distance Metric Learning for Large Margin Nearest Neighbor Classification.” Journal of Machine Learning Research 207-244.
[9] Nils Reimers and Iryna Gurevych. 2019. “Sentence-{BERT}: Sentence Embeddings using {S} iamese {BERT}-Networks.” Proceedings of the 2019 Conference on Empirical Methods in Natural Language Processing and the 9th International Joint Conference on Natural Language Processing (EMNLP-IJCNLP). Hong Kong, China: Association for Computational Linguistics. 3982-3992.
[10] H Li, Y Ma, Z Ma, H Zhu, Weibo text sentiment analysis based on bert and deep learning, Applied Sciences, 2021.
[11] Y. Wu et al., “Google's Neural Machine Translation System: Bridging the Gap between Machine Human and Translation,” 2016: https://arxiv.org/abs/1609.08144

1. A dialog system, comprising:
an input interface for acquiring an input representation of an input by receiving the input and deriving the input representation from the input or by receiving the input representation, the input representation being an audio signal representation or a speech representation or a text representation, wherein the input representation comprises a plurality of input representation elements,
a preprocessor for preprocessing the input representation to generate preprocessed information, such that the preprocessed information comprises a plurality of preprocessed information elements, and such that each of two or more of the plurality of preprocessed information elements depends on at least two of the plurality of information representation elements,
two or more information extraction processors, wherein each of the two or more information extraction processors is suitable to generate derived information from the preprocessed information according to an information extraction rule specific for the information extraction processor, and different from an information extraction rule of any other one of the two or more information extraction processors, and
an output interface for generating an output, being an audio output and/or a textual output and/or visual output and/or being a signal for steering a machine, depending on the derived information from one or more of the two or more information extraction processors.

2. The dialog system according to claim 1,
wherein the dialog system is configured to select at least one of the two or more information extraction processors, such that only those of the two or more information extraction processors that have been selected, are to generate, depending on their information extraction rules, the derived information.

3. The dialog system according to claim 1,
wherein at least two of the two or more information extraction processors are to generate the derived information from the preprocessed information depending on their information extraction rules.

4. The dialog system according to claim 3,
wherein said at least two of the two or more information extraction processors are configured to generate the derived information from the preprocessed information in parallel.

5. The dialog system according to claim 1,
wherein the dialog system is configured to select the at least one of the two or more information extraction processors depending on a current state of a dialog, such that those of the two or more information extraction processors that have been selected, are to generate, depending on their information extraction rules, the derived information.

6. The dialog system according to claim 5,
wherein at least two information extraction processors of the two or more information extraction processors are dialog-state-dependent,
wherein the dialog system is configured to select one or more information extraction processors of the at least two information extraction processors, which are dialog-state-dependent, depending on the current state of the dialog, such that only those of the at least two information extraction processors, which are associated with the current state of the dialog, are selected, and
wherein the one or more information extraction processors that have been selected are configured to generate the derived information depending on their information extraction rules.

7. The dialog system according to claim 6,
wherein the dialog system comprises three or more information extraction processors as the two or more information extraction processors,
wherein at least one information extraction processor of the three or more information extraction processors is dialog-state-independent,
wherein the at least one information extraction processor, which is dialog-state-independent, is configured to always generate, depending on its information extraction rule, the derived information, independent from the current state.

8. The dialog system according to claim 1,
wherein each of at least two information extraction processors of the two or more information extraction processors is suitable to generate specific information being specific for said information extraction processor according to a modification rule, wherein said information extraction processor is suitable to generate the derived information from the specific information for said information extraction processor according to the information extraction rule specific for the information extraction processor,
wherein said information extraction processor is suitable to generate the specific information for said information extraction processor according to the modification rule, such that the specific information for said information extraction processor is different from any specific information of any other information extraction processor of the at least two information extraction processors.

9. The dialog system according to claim 8,
wherein each of at least one of the at least two information extraction processors is configured to generate the specific information for said information extraction processor using the derived information of another one of the at least two information extraction processors.

10. The apparatus according to claim 5,
wherein each of at least two information extraction processors of the two or more information extraction processors is suitable to generate specific information being specific for said information extraction processor according to a modification rule, wherein said information extraction processor is suitable to generate the derived information from the specific information for said information extraction processor according to the information extraction rule specific for the information extraction processor,
wherein said information extraction processor is suitable to generate the specific information for said information extraction processor according to the modification rule, such that the specific information for said information extraction processor is different from any specific information of any other information extraction processor of the at least two information extraction processors, and
wherein the dialog system is configured to select at least one information extraction processor of the at least two information extraction processors depending on the current state of the dialog, such that each of said at least one information extraction processor is to generate the derived information from the specific information for said one of the at least one information extraction processor.

11. The dialog system according to claim 1,
wherein each of the two or more information extraction processors is a classification unit,
wherein each of the two or more classification units is suitable to generate the derived information from the preprocessed information such that the derived information indicates whether or not the input representation is associated with a class or indicates a probability that the input representation is associated with the class.

12. The dialog system according to claim 1,
wherein the preprocessed information comprises a numerical feature vector,
wherein the plurality of preprocessed information elements comprises a plurality of numerical vector components of the feature vector.

13. The dialog system according to claim 12,
wherein the input interface is configured to acquire a raw input text as the input representation, being a sequence of words,
wherein the preprocessor is configured to tokenize the raw input text using a tokenization method to acquire a plurality of tokens,
wherein the preprocessor is configured to generate a multi-dimensional numerical vector for each of the plurality of tokens to acquire a plurality of multi-dimensional numerical vectors,
wherein the preprocessor is configured to generate the numerical feature vector of the preprocessed information by combining the plurality of multi-dimensional numerical vectors for the plurality of tokens.

14. The dialog system according to claim 10,
wherein the preprocessed information comprises a numerical feature vector,
wherein the plurality of preprocessed information elements comprises a plurality of numerical vector components of the feature vector,
wherein for each information extraction processor of the at least one information extraction processors that has been selected,
said information extraction processor is configured to generate the specific information such that it comprises a numerical feature vector depending on the numerical feature vector of the preprocessed information, and
said information extraction processor is configured to generate the derived information for said information extraction processor by determining a distance metric between the specific information of said information extraction processor and a numerical class representation vector being associated with said information extraction processor.

15. The dialog system according to claim 4,
wherein each information extraction processor of the two or more information extraction processors comprises a neural network, wherein the neural network comprises at least one of an attention layer, a pooling layer and a fully-connected layer,
wherein the neural network is configured to receive the preprocessed information as input, and is configured to output the derived information; or
wherein the neural network is configured to receive the specific information for said information extraction processor as input, and is configured to output the derived information.

16. The dialog system according to claim 1,
wherein the pre-processor is configured to generate the preprocessed information such that each of the plurality of information elements depends on each of the plurality of information representation elements.

17. The dialog system according to claim 1,
wherein the pre-processor comprises a neural network which is configured to receive the plurality of input representation elements as input, and which is configured to output the plurality of preprocessed information elements as output,
wherein the neural network comprises at least two of an attention layer, a pooling layer and a fully-connected layer.

18. The dialog system according to claim 1,
wherein the input representation comprises a numerical multi-dimensional sentence representation vector, or wherein the preprocessor is configured to generate the numerical multi-dimensional sentence representation vector from the input representation, wherein the multi-dimensional sentence representation vector comprises three or more numerical vector elements, wherein each of the three or more numerical vector elements is associated with one of a plurality of dimensions.

19. The dialog system according to claim 18,
wherein, for each two pairs of the plurality of numerical multi-dimensional sentence representation vectors for a plurality of sentences of the input representation, two numerical multi-dimensional sentence representation vectors of a first one of the two pairs of the numerical multi-dimensional sentence representation vectors that identify two first sentences with semantically related meaning comprise a smaller spatial distance in a multi-dimensional space, in which the plurality of numerical multi-dimensional sentence representation vectors is defined, than two numerical multi-dimensional sentence representation vectors of a second one of the two pairs of the numerical multi-dimensional sentence representation vectors that identify two second sentences with semantically non-related meaning; or,
the preprocessor is configured to generate the plurality of numerical multi-dimensional sentence representation vectors, such that for each two pairs of the plurality of numerical multi-dimensional sentence representation vectors, two numerical multi-dimensional sentence representation vectors of a first one of the two pairs of the numerical multi-dimensional sentence representation vectors that identify two first sentences with semantically related meaning comprise a smaller spatial distance in a multi-dimensional space, in which the plurality of numerical multi-dimensional sentence representation vectors is defined, than two numerical multi-dimensional sentence representation vectors of a second one of the two pairs of the numerical multi-dimensional sentence representation vectors that identify two second sentences with semantically non-related meaning.

20. A dialog system, comprising:
an input interface for acquiring an input representation of an input by receiving the input and deriving the input representation from the input or by receiving the input representation, the input representation being an audio signal representation or a speech representation or a text representation, wherein the input representation comprises a plurality of input representation elements, and
two or more information extraction processors, wherein each of the two or more information extraction processors is suitable to generate derived information depending on the input representation according to an information extraction rule specific for the information extraction processor, and different from an information extraction rule of any other one of the two or more information extraction processors, and
an output interface for generating an output, being an audio output and/or a textual output and/or visual output and/or being a signal for steering a machine, depending on the derived information from one or more of the two or more information extraction processors,
wherein at least two information extraction processors of the two or more information extraction processors are dialog-state-dependent,
wherein the dialog system is configured to select one or more information extraction processors of the at least two information extraction processors, which are dialog-state-dependent, depending on a current state of the dialog, such that only those of the at least two information extraction processors, which are associated with the current state of the dialog, are selected, and
wherein the one or more information extraction processors that have been selected are configured to generate the derived information depending on their information extraction rules.

21. The dialog system according to claim 20,
wherein the dialog system comprises three or more information extraction processors as the two or more information extraction processors,
wherein at least one information extraction processor of the three or more information extraction processors is dialog-state-independent,
wherein the at least one information extraction processor, which is dialog-state-independent, is configured to always generate, depending on its information extraction rule, the derived information, independent from the current state.

22. The dialog system according to claim 20,
wherein each of at least two information extraction processors of the two or more information extraction processors is suitable to generate specific information being specific for said information extraction processor according to a modification rule, wherein said information extraction processor is suitable to generate the derived information from the specific information for said information extraction processor according to the information extraction rule specific for the information extraction processor,
wherein said information extraction processor is suitable to generate the specific information for said information extraction processor according to the modification rule, such that the specific information for said information extraction processor is different from any specific information of any other information extraction processor of the at least two information extraction processors.

23. The dialog system according to claim 1,
wherein the input interface is configured to receive the input being a speech signal or an audio signal,
wherein the input interface is configured to apply a speech recognition algorithm on the speech signal or on the audio signal to acquire a text representation of the speech signal or of the audio signal as the input representation.

24. The dialog system according to claim 20,
wherein the input interface is configured to receive the input being a speech signal or an audio signal,
wherein the input interface is configured to apply a speech recognition algorithm on the speech signal or on the audio signal to acquire a text representation of the speech signal or of the audio signal as the input representation.

25. A method, comprising:
acquiring an input representation of an input by an input interface of a dialog system, wherein the input interface acquires the input representation by receiving the input and deriving the input representation from the input or by receiving the input representation, wherein the input representation is an audio signal representation or a speech representation or a text representation, wherein the input representation comprises a plurality of input representation elements,
preprocessing the input representation by a preprocessor of the dialog system to generate preprocessed information, such that the preprocessed information comprises a plurality of preprocessed information elements, and such that each of two or more of the plurality of preprocessed information elements depends on at least two of the plurality of information representation elements; wherein each of two or more information extraction processors of the dialog system is suitable to generate derived information from the preprocessed information according to an information extraction rule specific for the information extraction processor, and different from an information extraction rule of any other one of the two or more information extraction processors, and
generating, by an output interface of the dialog system, an output, being an audio output and/or a textual and/or visual output and/or being a signal for steering a machine, depending on the derived information from one or more of the two or more information extraction processors.

26. A method, comprising:
acquiring an input representation of an input by an input interface of a dialog system, wherein the input interface acquires the input representation by receiving the input and deriving the input representation from the input or by receiving the input representation, wherein the input representation is an audio signal representation or a speech representation or a text representation, wherein the input representation comprises a plurality of input representation elements; wherein each of two or more information extraction processors of the dialog system is suitable to generate derived information depending on the input representation according to an information extraction rule specific for the information extraction processor, and different from an information extraction rule of any other one of the two or more information extraction processors, and
generating, by an output interface of the dialog system, an output, being an audio output and/or a textual and/or visual output and/or being a signal for steering a machine, depending on the derived information from one or more of the two or more information extraction processors,
wherein at least two information extraction processors of the two or more information extraction processors are dialog-state-dependent,
wherein the method comprises selecting by the dialog system one or more information extraction processors of the at least two information extraction processors, which are dialog-state-dependent, depending on a current state of the dialog, such that only those of the at least two information extraction processors, which are associated with the current state of the dialog, are selected, and
wherein the method comprises generating the derived information by the one or more information extraction processors that have been selected depending on their information extraction rules.

27. A non-transitory computer-readable medium comprising a computer program for implementing the method of claim 25 when being executed on a computer or signal processor.

28. A non-transitory computer-readable medium comprising a computer program for implementing the method of claim 26 when being executed on a computer or signal processor.
